(19) United States
(12) Patent Application Publication
(10) Pub. No.: US 2009/0298636 A1
(43) Pub. Date: Dec. 3, 2009

(54) Gear-type reduction unit, particulary for rotary platforms for sun-following devices

(75) Inventors: Pierluigi Zingale, Martellago (IT); Alessandro Cognolato, S.Angelo Di Piove Di Sacco (IT)

Correspondence Address: MODIANO & ASSOCIATI, Via Meravigli, 16, MILANO, 20123, IT

(73) Assignee: M.G. MINI GEARS S.P.A.

(21) Appl. No.: 12/379,709

(22) Filed: Feb. 27, 2009

(30) Foreign Application Priority Data
May 27, 2008 (IT) PD2008A000151

(51) Int. Cl. F16H 1/32

(52) U.S. Cl. 475/176

(57) ABSTRACT

A gear-type reduction unit, particularly for rotary platforms for sun-following devices, which comprises two main components, associated for rotation with respect to each other about a main rotation axis, a driving shaft, supported for rotation about the main axis, by a first one of the main components, a transmission element provided with two pinions, which are jointly connected and have an axis that is eccentric with respect to the main axis, a connecting member for mutual eccentric rotation of the transmission element with respect to the driving shaft, a first ring gear and a second ring gear with internal sets of teeth, which are jointly connected respectively to the first and second of the main components and mesh respectively with the first and the second of the pinions, and a play recovery device to take up slack between the pinions and the ring gears.

### BACKGROUND OF THE INVENTION

The need to resort to utilization of the so-called supplemental energy sources is currently strongly felt.

Among these types of energy source, there is great development in the field of the utilization of electric power generated by solar radiation devices, such as photovoltaic panels and concentrating units or panels.

As is known, solar panels have their maximum energy efficiency when the incidence of the rays of the sun is perpendicular to their surface.

In order to keep this efficiency at maximum throughout the day, devices for reorienting the panel throughout the day, commonly known as sun-following devices, are currently commercially available.

These devices are also used to support solar mirrors, which require continuous reorientation to follow the path of the sun in the sky.

Generally, currently the structure of a sun-following device has a footing that supports rotatably a supporting element for the solar mirror or panel.

Actuation of the mutual rotation of the support with respect to the footing is entrusted to an electric motor.

The electric motor turns the support with respect to the footing by means of a gear-type reduction unit, which generally has a reduction ratio of approximately 1:10.000.

As is known, the rotation rate of the support of the panel or mirror with respect to the footing is in fact very low, since it is obviously linked to the required rotation, which covers substantially 180° over the day.

The needs found in the field of gear-type reduction units for sun-following devices consist substantially in having a reduction device that allows high precision in orientation on command of the electric motor, as well as a device that is highly rigid, in order to withstand the stresses imparted by the wind due to the sail effect on the panel.

In order to meet these needs, reduction units are currently provided which have sequentially connected worm gears.

However, this type of structure has drawbacks; as is known, the gear wheel-worm gear system in fact does not have particular precision in transmitting motion between the driving element and the driven element.

Further, as is known, gear wheel-worm gear transmissions are low-efficiency mechanical transmissions.

Further, the meshing between the gear wheel and the worm gear is provided by means of a limited number of teeth, to the full disadvantage of its rigidity and structural strength.

### SUMMARY OF THE INVENTION

The aim of the present invention is to provide a gear-type reduction unit particularly for rotary platforms for sun-following devices that meets the above-mentioned requirements, by obviating the noted drawbacks, thus allowing to have high structural rigidity and strength.

Within this aim, an object of the invention is to provide a gear-type reduction unit that allows high precision in transmitting motion between the driving element and the driven element.

Another object of the invention is to provide a reduction unit that has a smaller space occupation than currently known reduction units.

Another object of the invention is to provide a reduction unit that is simple and easy to use and can be manufactured with low costs.

This aim and these and other objects, which will become better apparent hereinafter, are achieved by a gear-type reduction unit, particularly for rotary platforms for sun-following devices, comprising two main components, one connected to a footing and the other one supporting a solar mirror or panel, associated so that they can rotate with respect to each other about a main rotation axis, characterized in that it comprises:
a driving shaft, which is connected by means of a first gear to a motor in order to be actuated thereby, said driving shaft being supported, so that it can rotate about said main axis, by a first component of said two main components,
a transmission element provided with two jointly connected and coaxial pinions, the common axis of said pinions defining a secondary axis that is parallel to said main axis and is distinct with respect to it, means for mutual rotation connecting said transmission element to said driving shaft, said transmission element being able to rotate with respect to said driving shaft about said secondary axis eccentrically with respect to said main axis,
a first ring gear with internal teeth, which is jointly connected to said first component and meshes with a first one of said pinions,
a second ring gear with internal teeth, which is jointly connected to the second of said main components and meshes with the second one of said pinions.

### BRIEF DESCRIPTION OF THE DRAWINGS

Further characteristics and advantages of the invention will become better apparent from the following detailed description of a preferred but not exclusive embodiment of the reduction unit according to the invention, illustrated by way of non-limiting example in the accompanying drawings, wherein:

FIG. 1 is a transverse sectional view of a reduction unit according to the invention;

FIG. 2 is an enlarged-scale sectional view of a detail of the reduction unit according to the invention;

FIG. 3 is a perspective diagram of the reduction unit according to the invention;

FIG. 4 is a diagram of the reduction unit according to the invention;

FIG. 5 is a partially sectional enlarged-scale view of a detail of the reduction unit according to the invention.

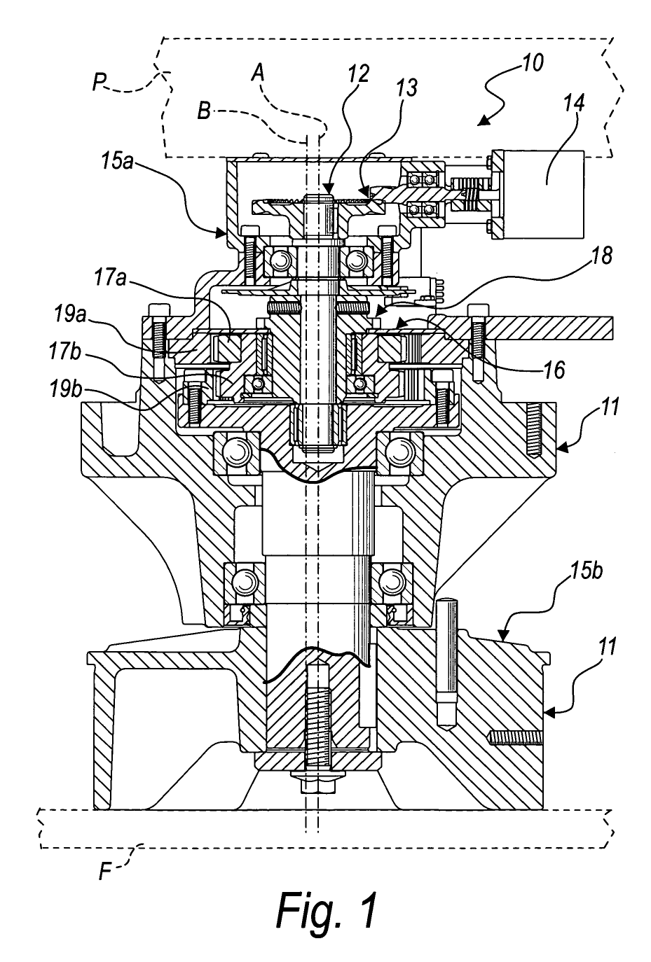

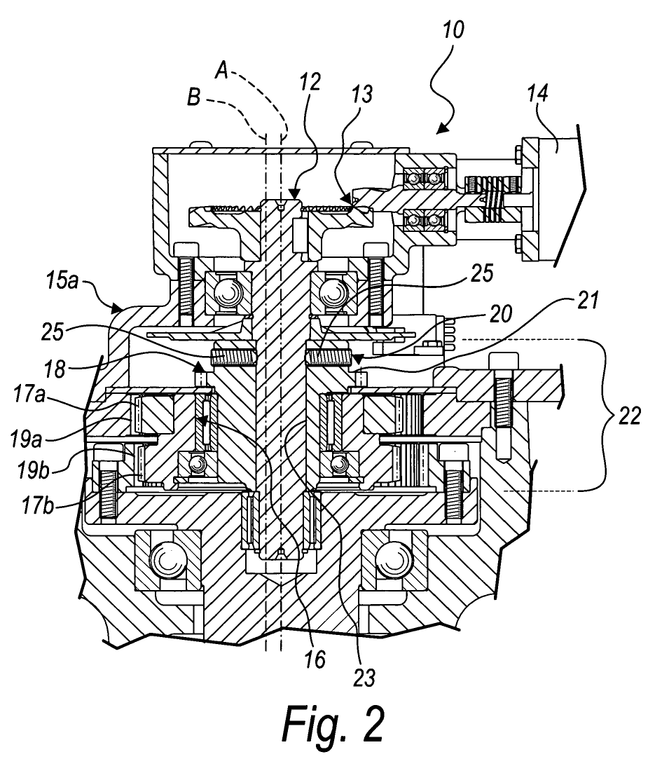

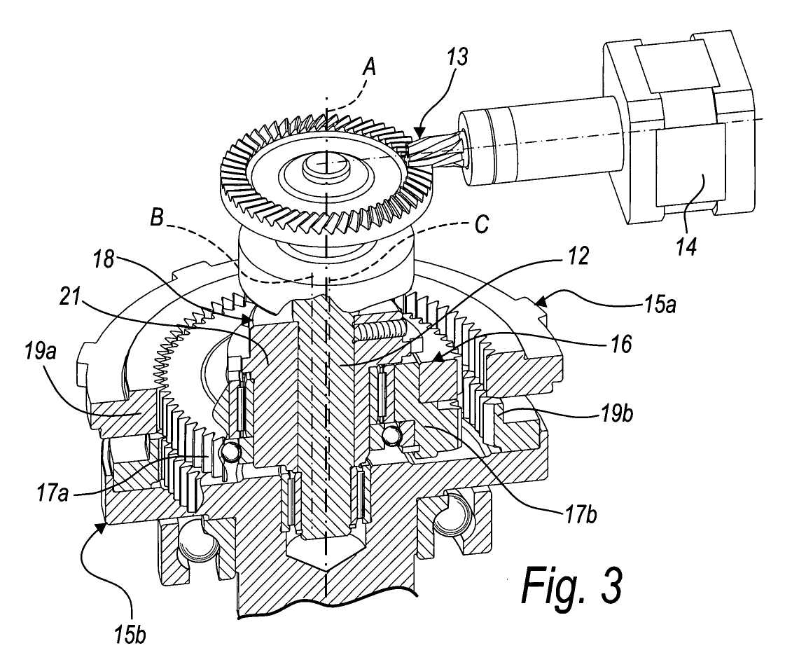

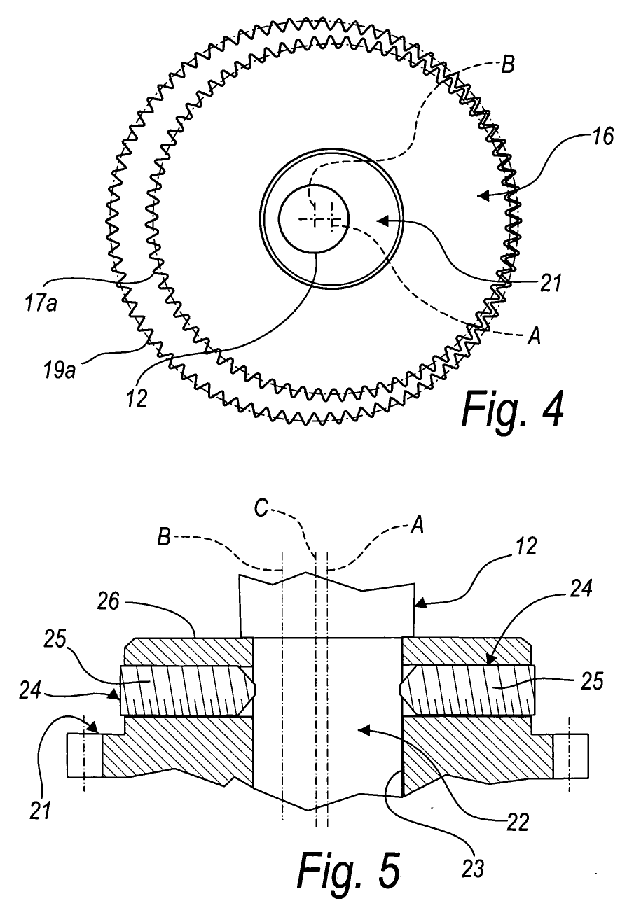

### DESCRIPTION OF THE PREFERRED EMBODIMENTS

It is noted that anything found to be already known during the patenting process is understood not to be claimed and to be the subject of a disclaimer.

With reference to the figures, the reference numeral 10 generally designates a gear-type reduction unit, particularly for rotary platforms for sun-following devices, which comprises two main components 11, one of which is connected to a footing F, the other one supporting a solar mirror or panel P, mutually associated so as to be able to rotate with respect to each other about a main rotation axis A.

The reduction unit 10 according to the invention mainly comprises
a driving shaft 12, which is connected by means of a first gear 13 to a motor 14 in order to be actuated by it, the driving shaft 12 being supported, so that it can rotate about the main axis A, by a first component 15a of the two main components 11,
a transmission element 16 provided with two pinions 17a and 17b that are jointly connected and coaxial, the common axis of the pinions 17a and 17b defining a secondary axis B, which is parallel to the main axis A and is distinct from it, connection means 18 for mutual rotation connecting the transmission element 16 to the driving shaft 12, so that the transmission element 16 can rotate with respect to the driving shaft 12 about the secondary axis B, eccentrically with respect to the main axis A,
a first ring gear 19a with an internal set of teeth that is jointly connected to the first one 15a of the main components 11 and meshes with the first one 17a of the two pinions 17a and 17b,
a second ring gear 19b with an internal set of teeth that is jointly connected to the second one 15b of the main components 11 and meshes with the second one 17b of the two pinions 17a and 17b,
play recovery means 20 to take up slack from production plays between the pinions 17a and 17b and the ring gears 19a and 19b.

In the embodiment shown in the accompanying figures, the first component 15a supports a solar mirror or panel and the second component 15b is connected to a footing.

Advantageously, the connection means 18 for mutual rotation comprise a member 21 for connecting the transmission element 16 to the driving shaft 12, which is thus associated with the transmission element 16 so as to be able to rotate with respect to it coaxially to the secondary axis B.

The driving shaft 12 is associated with the connecting member 21 in an eccentric position with respect to the secondary axis B.

The play recovery means 20 conveniently comprise a portion 22 of the shank of the driving shaft 12 which has a substantially cylindrical cross-section and the axis of which defines an auxiliary axis C that is parallel and distinct with respect to the main axis A.

The connecting member 21 comprises a hole 23 for mating with the portion 22 that is shaped complementarily thereto in order to accommodate such portion in a manner that allows mutual rotation about the auxiliary axis C.

The play recovery means 20 advantageously comprise adjustment means for adjusting the eccentricity of the secondary axis B with respect to the main axis A, which preferably comprise reversible means 24 for locking the rotation of the driving shaft 12 about the main axis A with respect to the connecting member 21.

The locking means 24 conveniently comprise grubs 25 for locking the connecting member 21 to the driving shaft 12 during use, which can be fastened thereto through seats provided on a collar 26 of the connecting member 21 that forms a part of the hole 23.

In an alternative embodiment of the reduction unit according to the invention that is not shown in the accompanying drawings, such adjustment means comprise elastic means, such as a torsion spring, for contrasting a rotation of the driving shaft with respect to the connecting member that reduces the eccentricity of the secondary axis with respect to the main axis, moving it closer thereto.

During use, therefore, such torsion spring forces the connecting member and the shaft into a configuration of maximum eccentricity of the secondary axis B with respect to the main axis A, contrasting rotations thereof aimed at reducing such eccentricity.

A reduction unit according to the invention can comprise, simultaneously or as an alternative, the locking means and the elastic contrast means.

In the described embodiment of the reduction unit 10, the operator, in order to recover the production plays, i.e. to take up slack, between the pinions 17a and 17b and the ring gears 19a and 19b, turns about the main axis A the driving shaft 12, so that the portion 22 of its shank rotates within the hole 23 in the connecting member 21, pushing its pinions 17a and 17b into abutment with the ring gears 19a and 19b with which they mesh.

When play or slack is recovered, i.e., when the abutment of the pinions 17a and 17b against the ring gears 19a and 19b prevents a further rotation of the driving shaft 12 within the connecting member 21, such pinions are mutually fixed by means of the provided grubs 25.

If a reduction unit according to the invention is provided with said torsion spring, such spring forces a rotation of the connecting member with respect to the driving shaft such as to push the pinions into abutment against the ring gears with which they mesh, thus recovering any production plays that might be present between them.

In practice it has been found that the invention achieves the proposed aim and objects, providing a reduction unit that has high rigidity and structural strength since the meshing of the pinions with the ring gears provided with internal teeth occurs at a plurality of teeth, thus distributing the stresses that they mutually exchange.

Further, a reduction unit according to the invention has high precision in transmitting motion, ensured by the precision of the meshing between the pinions and the internally toothed gears, which can also be obtained by way of the recovery of the production plays between them.

A reduction unit according to the invention also allows to provide a reduction unit that has smaller space occupations than currently known reduction units, provided by means of worm gear-gear wheel series.

The invention thus conceived is susceptible of numerous modifications and variations, all which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2008A000151 from which this application claims priority are incorporated herein by reference.

What is claimed is:

1. A gear reduction unit for rotary platforms for sun-following devices, comprising two main components, one of which is connected to a footing, and the other one supporting a solar mirror or panel, said two main components being connected to each other so as to be able to rotate with respect to each other about a main rotation axis, the unit comprising:
a motor;
a first gear;
a driving shaft, which is connected for actuation by way of said first gear to said motor, said driving shaft being supported, so as to be rotatable about said main axis, following to actuation by said motor, by a first component of said two main components;
a transmission element provided with two pinions that are jointly connected and coaxial with respect to a common axis, the common axis of said pinions defining a secondary axis, which is parallel to said main axis and is distinct therefrom;
connection means for mutual rotation that connect said transmission element to said driving shaft, said transmission element being able to rotate with respect to said driving shaft about said secondary axis, eccentrically with respect to said main axis;
a first ring gear having an internal set of teeth thereof that is jointly connected to the first one of said main components and meshes with the first one of said two pinions; and
a second ring gear having an internal set of teeth thereof that is jointly connected to the second one of said main components and meshes with the second one of said two pinions.

2. A gear reduction unit for rotary platforms for sun-following devices, comprising two main components, one of which is connected to a footing, and the other one supporting a solar mirror or panel, said two main components being connected to each other so as to be able to rotate with respect to each other about a main rotation axis, the unit comprising:
a motor;
a first gear;
a driving shaft, which is connected for actuation by way of said first gear to said motor, said driving shaft being supported, so as to be rotatable about said main axis, following to actuation by said motor, by a first component of said two main components;
a transmission element provided with two pinions that are jointly connected and coaxial with respect to a common axis, the common axis of said two pinions defining a secondary axis, which is parallel to said main axis and is distinct therefrom;
connection means for mutual rotation that connect said transmission element to said driving shaft, said transmission element being able to rotate with respect to said driving shaft about said secondary axis, eccentrically with respect to said main axis;
a first ring gear having an internal set of teeth thereof that is jointly connected to the first one of said main components and meshes with the first one of said pinions;
a second ring gear having an internal set of teeth thereof that is jointly connected to the second one of said main components and meshes with the second one of said two pinions;
play recovery means to take up slack between said pinions and said ring gears.

3. The reduction unit according to claim 2, wherein said connection means for mutual rotation comprise a connecting member between said transmission element and said driving shaft, said connecting member being associated with said transmission element so as to rotate coaxially with respect thereto, coaxially to said secondary axis, said driving shaft being associated with said connecting member in an eccentric position with respect to said secondary axis.

4. The reduction unit according to claim 3, wherein said shaft comprises a shank portion thereof that has a substantially cylindrical cross-section, and a longitudinal axis defining an auxiliary axis that is parallel and distinct with respect to said main axis, said play recovery means comprising said portion of said shank, said connecting member comprising a hole for mating with said shank portion, which is shaped complementarily thereto in order to accommodate said shank portion so as to allow mutual rotation about said auxiliary axis, said play recovery means further comprising adjustment means for adjusting eccentricity of said secondary axis with respect to said main axis.

5. The reduction unit according to claim 4, wherein said adjustment means comprise locking means for reversible locking of a rotation about said main axis of said driving shaft with respect to said connecting member.

6. The reduction unit according to claim 4, wherein said adjustment means comprise elastic means for contrasting a rotation of said driving shaft, with respect to said connecting member, in order to reduce eccentricity of said secondary axis with respect to said main axis.
